(19) United States
(12) Patent Application Publication
(10) Pub. No.: US 2015/0178714 A1
(43) Pub. Date: Jun. 25, 2015

(54) METHOD FOR PROVIDING CONNECTIVITY FROM A TRANSPORT VEHICLE

(71) Applicant: TRANSCAST, INC., Houston, TX (US)

(72) Inventor: Guillermo Antonio Amtmann, Houston, TX (US)

(73) Assignee: TRANSCAST, INC., Houston, TX (US)

(21) Appl. No.: 14/207,202

(22) Filed: Mar. 12, 2014

Related U.S. Application Data
(63) Continuation-in-part of application No. 14/090,836, filed on Nov. 26, 2013.

(51) Int. Cl. G06Q 20/32; G06Q 50/30

(52) U.S. Cl. CPC G06Q 20/3221; G06Q 50/30

(57) ABSTRACT

A method for providing connectivity from a transport vehicle to a transport vehicle company, a financial institution, and/or a third party provider, and an administrative processor via a network using administrative data storage, a dynamic library of viewing content, and a dynamic driver profile. The method uses a portable media device installed in the transport vehicle for viewing content using an interactive dynamic customized dashboard. The method enables purchase of goods and services from the transport vehicle, while the transport vehicle is in motion, recharging of a client device while in the transport vehicle, and providing automated driver check in and out while recording activity of the transport vehicle during defined periods of time.

### CROSS REFERENCE TO RELATED APPLICATIONS

The present application is a Continuation in Part of co-pending U.S. patent application Ser. No. 14/090,836 filed on Nov. 26, 2013, entitled “ONLINE SELF CONTAINED PORTABLE INTERACTIVE TRANSACTIONAL SYSTEM.” This reference is hereby incorporated in its entirety

### FIELD

The present embodiments generally relate to a method for presenting purchase options to a passenger in a common carrier vehicle and providing connectivity from a transport vehicle to a transport vehicle company, a financial institution, and/or a third party provider and an administrative processor via a network.

### BACKGROUND

A need exists for a method usable with a compact, self-contained system capable of interacting with the passenger of a vehicle enabling the passenger to make purchases including but not limited to downloading internet content, and purchasing goods and services.

A need exists for a method to make use of otherwise unproductive time spent riding in a transport vehicle.

A further need exists for a method that can provide benefits to the community, taxi companies and independent drivers, by using technology that will have a positive impact on the environment and promote productivity by empowering the public transportation industry to deliver tools and methods to perform daily tasks while confined in a transportation vehicle.

A further need exists for a method for offering products and services to passengers, while accepting multiple forms of payment.

The present embodiments meet these needs.

### BRIEF DESCRIPTION OF THE DRAWINGS

The detailed description will be better understood in conjunction with the accompanying drawings as follows:

FIG. 1 is a communication diagram of components of a system usable with the method.

FIG. 2 is a diagram of the components of an embodiment of a portable media device.

FIG. 3 depicts the portable media device installed in a transport vehicle.

FIG. 4 depicts the portable media device data storage.

FIG. 5 shows the dynamic driver profile.

FIG. 6 shows an embodiment of the onboard trip-tracking computer.

FIGS. 7A-7C depict an embodiment of the administrative data storage.

FIG. 8 depicts an embodiment of a portable media device in a holding case mounted to a headrest of a transport vehicle.

FIG. 9 depicts the steps of the method for driver check in.

FIG. 10 depicts an embodiment of the steps of the method for a passenger or a driver to top up their cell phone with minutes.

FIG. 11 depicts the steps of the method for a user to charge a cell phone.

FIG. 12 depicts the steps of the method for driver check out.

FIG. 13 depicts the steps of the method for the passenger to choose a local events option.

FIG. 14 depicts steps of the method for the passenger to choose to purchase a phone card.

FIG. 15 depicts steps of the method for the passenger to choose a local weather option and view weather.

FIG. 16 depicts steps of the method for the passenger to choose to purchase special offers.

The present embodiments are detailed below with reference to the listed Figures.

### DETAILED DESCRIPTION OF THE EMBODIMENTS

Before explaining the present method in detail, it is to be understood that the method is not limited to the particular embodiments and that it can be practiced or carried out in various ways.

The present embodiments generally relate to a method for presenting purchase options to a passenger in a common carrier vehicle and providing connectivity from a transport vehicle to a transport vehicle company, a financial institution, and/or a third party provider and an administrative processor via a network.

A benefit of the method is that it conserves fossil fuels by enabling a passenger in a transport vehicle to shop while riding to a destination, saving an extra shopping trip and saves trees by enabling users to receive their receipts through an electronic medium.

A benefit of the method is being connected to the Internet and receiving news about a traffic accident that is on the roadway, the passenger can tell the driver how to avoid an emergency situation.

A benefit of the method is that it allows payment by credit or debit card and near field communication payment methods, such as GOOGLE™ Wallet, or RFID (Radio-Frequency Identification) chips embedded in plastic embodiments and allows the driver to carry less cash, thereby reducing the risk of loss and theft.

A benefit of the method is that it allows instant communication to services such as fire, police, and ambulance in the event of an emergency.

A benefit of the method is that it allows video and audio recording in the event of an emergency, thereby providing valuable information to insurance, police, fire, or medical personnel.

A passenger will see an interactive system usable with the method upon entering a vehicle. The system is user friendly and allows the passenger to make use of otherwise unproductive time.

The passenger can intuitively select options to view products and services to purchase that are shown on a display. The passenger is allowed to select multiple items to purchase from multiple screens if desired. In many cases, a passenger can complete a purchase in as little as three steps.

The passenger can combine multiple items selected for purchase into a single payment. The passenger can pay using multiple forms of payment. Such as credit cards, debit cards, private label payment cards, or other electronically trackable payment means.

The method can be usable with a system that can allow the passenger to combine a fare for travel with one or more purchases.

The method can be usable with a system that can accept payment using a magnetic card reader, a near field communication reader, a smart chip reader, or manual entry.

The method can be usable with a system that can process the payment while the vehicle is in transit.

Upon payment, the passenger can choose to receive proof of payment via printed receipt, email, text, or similar methods.

The method can be usable with a system that can provide a hotspot for internet access, power outlets, information, access to the internet on the interactive system, and entertainment for the passenger.

A common carrier can use the system to track vehicles, generate additional revenue, transmit data, and gather data.

The method can be implemented by placing a portable media device in a transport vehicle. A transport vehicle company can provide this to its drivers.

The portable media device can connect to an administrative data storage to track driver information, shift activity information, and revenue information.

The method can allow for the distribution of revenue to all relevant parties.

The method can be usable with a portable media device with a self-contained processor and data storage. The portable media device can be installed within a vehicle for use by a passenger.

The method can be usable with an administrative processor and administrative data storage wirelessly connected to the portable media device.

The administrative data storage can have a set of computer instructions that monitors the status of the portable device.

The administrative data storage and processor can update the computer instructions resident in the portable media device.

The term “third party provider” as used herein can refer to suppliers of movies and entertainment via the internet, online merchants and suppliers of products, such as AMAZON™, online service providers, such as a phone carrier, a long distance company, online charities, and the like.

The term “financial institution” as used herein can refer to a credit card or debit card issuer, other payment processing companies, a bank, a credit union, a wire transfer service or money transfer service, a currency exchange, or other institutions that handle the transfer of funds.

The term “private label payment card” as used herein can refer to any card capable of identifying payments made. For example, this could refer to a gift card, a charge card, a hotel room key, a prepaid card, an issued voucher, or similar items. The private label payment card can be swiped like a credit card, or incorporate technologies such as smart chips or near field communication.

The term “shift statistics” as used herein can refer to quantitative and analytical measurements and calculations including, but not limited to: length of shift, number of kilometers driven, number of trips made, number of non-fare transactions, individual amounts of non-fare transactions, total amount of non-fare transactions, average amounts of non-fare transactions per trip, total amount of trip fares, number of dispatched trips, amounts of fares for dispatched trips, and other useful information.

The term “targeted passenger profile” can refer to a profile containing demographic information and other useful marketing metrics about the passenger including but not limited to: age, ethnicity, gender, geographic pick up or drop off location, and other information used to customize content provided to the passenger.

The term “transport vehicle company” as used herein can refer to a taxi operator, a trucking company, limousine operators, a shuttle bus operator, or other operators of vehicles for hire.

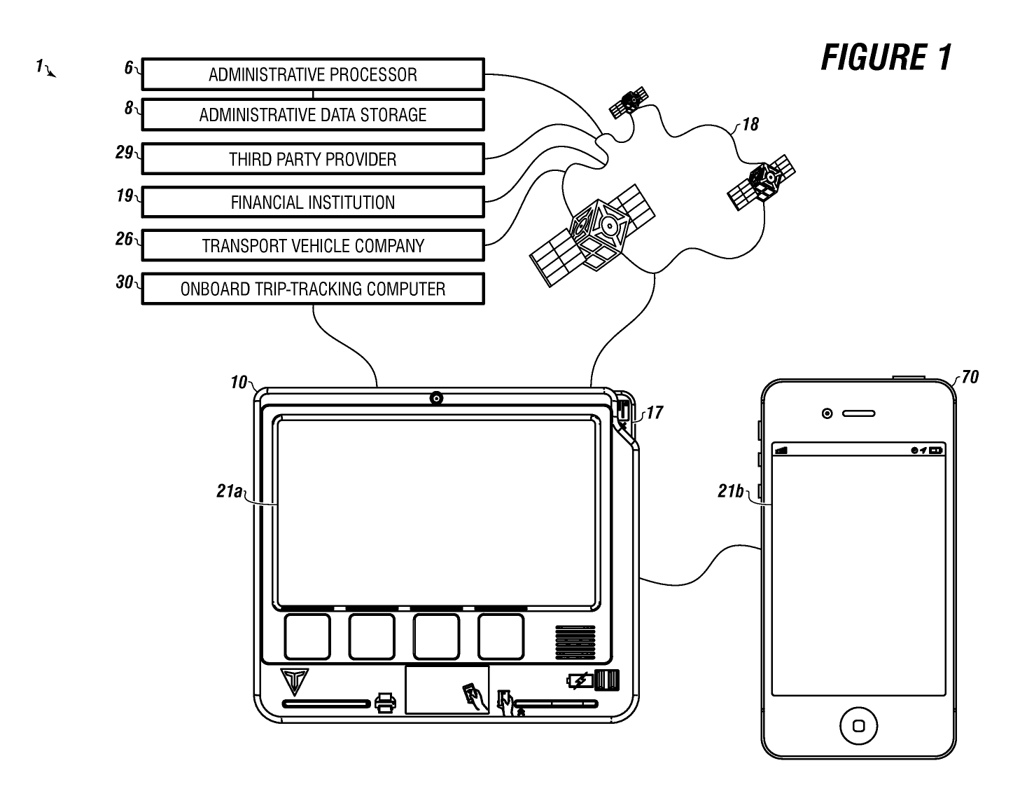

Turning now to the Figures, FIG. 1 depicts a communication diagram of a system usable with the method including the network and other components used by the system.

The system 1 can use a network 18 to be in communication with a transport vehicle company 26, a financial institution 19, and a third party provider 29.

An administrative processor 6 can be in communication with the network 18 and an administrative data storage 8.

An onboard trip-tracking computer 30 can also be in communication with the network 18.

A portable media device 10 can be in communication with the network 18. The portable media device 10 can have a portable media device processor.

A client device 70 can interact with the system 1 and the portable media device 10 and can receive content from the portable media device 10. The client device 70 can be a smart phone, a cell phone, a tablet, or a similar handheld device.

The portable media device 10 can comprise a payment reader 17, such as a magnetic card reader. The portable media device 10 can have a display 21a, or can transmit information to a display 21b on a client device 70.

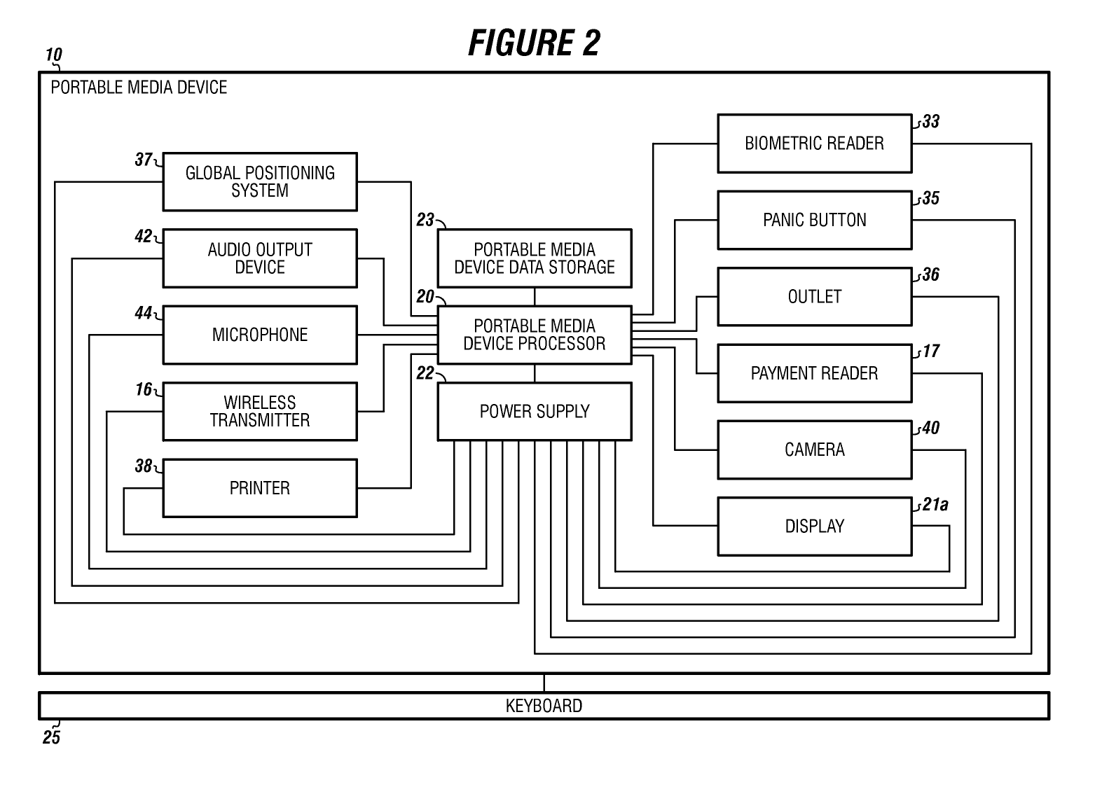

FIG. 2 depicts a diagram of the portable media device.

The portable media device 10 can have a display 21a that can communicate with the portable media device processor 20. In embodiments, the display 21a can be an interactive touchscreen or a display with a user input mechanism, such as a keyboard 25.

The portable media device 10 can include a portable media device data storage 23 which can be connected to the portable media device processor 20.

The portable media device 10 can have a wireless transmitter 16 that can remotely communicate with a network, any system connected to the network, such as a financial institution or third party provider, a client device via a protocol such as IEEE 802.11b/g/n or Bluetooth, or any system or device capable of sending and receiving data wirelessly.

The portable media device 10 can include a payment reader 17 which can be connected to the wireless transmitter 16 and the portable media device processor 20.

In embodiments the payment reader 17 can be a near field communication reader, a smart chip communication reader, a magnetic strip communication reader, or combinations thereof.

In embodiments, the portable media device 10 can have an outlet 36 for connection to a passenger device, such as the client device, that can enable a direct download of information or digital content from the portable media device to the client device or for recharging the client device.

In embodiments the outlet 36 can provide power and communication. In embodiments the outlet can be used only for power or only for communication if desired.

In embodiments the outlet 36 can be one of a variety of ports including, but not limited to: a serial port, a VGA port, a DVI port, an HDMI port, a universal serial bus port, a mini-universal serial bus port, a micro-universal serial bus port, an RS232 outlet, an IPHONE™ connector outlet, an IPAD™ connector outlet, a THUNDERBOLT™ outlet, a Firewire outlet, a tip-ring-sleeve connector such as those often used for audio connections, or combinations thereof. While this list encompasses much of the current and commonly used technology, future technology can result in the development of new connectors and outlets not currently in existence, which can easily be incorporated into the design.

In embodiments the portable media device 10 can have a camera 40 in communication with the portable media device processor 20 and additionally connected to a power supply 22 for recording at least one passenger in the transport vehicle.

In embodiments the portable media device 10 can have an audio output device 42, which in embodiments, can be a speaker, such as Advance Acoustic Technology model AK-3208BB-2. In alternate embodiments, the audio output device 42 can be the same as the outlet 36.

In embodiments the portable media device 10 can have a microphone 44 in communication with the portable media device processor 20 and connected to the power supply 22 which can allow a passenger to provide voice input using the portable media device, such as leaving a verbal message, or providing a biometric reading of a passenger's voice to access the system.

In embodiments the portable media device 10 can have a global positioning system 37 connected to the portable media device processor 20. The global positioning system can be used by the passenger or by a transport vehicle company to follow the driving patterns of the transport vehicle.

In embodiments the portable media device 10 can have a printer 38 in communication with the portable media device processor 20 and connected to the power supply 22. The printer 38 can be a thermal printer.

The display 21a can be an interactive touchscreen display, such as those made by Adlink, Inc. The display 21a can be a smart panel with an integrated screen and processor.

The portable media device 10 can have a panic button 35. The panic button can be connected to the portable media device processor 20 and the power supply 22. The panic button 35 can be a retractable push button.

The portable media device 10 can include a biometric reader 33. The biometric reader can be an interactive device that is capable of reading the biometric information for later verification and matching with a local or administrative data storage, such as a fingerprint reader made by Zhejiang SFG Technology Co. model number R305F. The biometric reader 33 can be implemented using software and existing hardware on the portable media device 10, or can be a self-contained unit.

The biometric reader can read any combination fingerprints, voice data, facial features, retinal information, or other biometrics used for purposes of uniquely identifying a person.

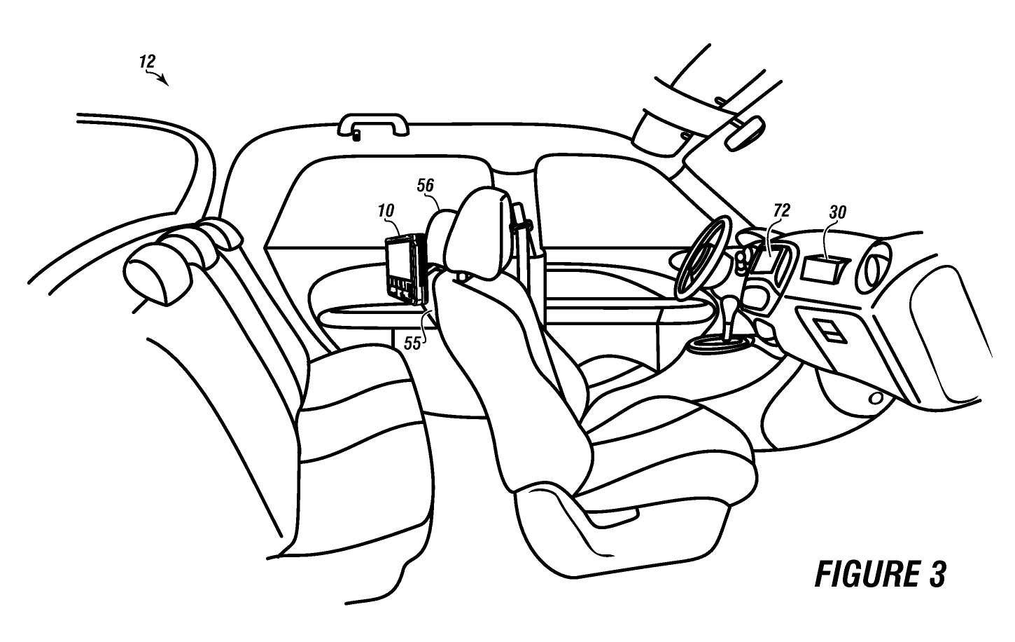

FIG. 3 depicts the portable media device 10 installed in a transport vehicle 12 adjacent the headrest 56 of the driver's seat 55 between the driver's seat and the passenger seat.

The transport vehicle 12 is shown with an onboard trip-tracking computer 30. The onboard trip-tracking computer 30 can communicate with the portable media device 10 via the network.

The onboard trip-tracking computer 30 can track transport vehicle information including vehicle fares, vehicle trip mileage, and vehicle trip duration associated with the transport vehicle using computer instructions in the onboard trip-tracking computer.

The transport vehicle 12 is shown with a driver media device 72 which can have a wired connection or wireless connection to the onboard trip-tracking computer 30. The driver media device 72 can have a wired connection or wireless connection to the portable media device 10.

In embodiments, the portable media device 10 can provide viewing content to a driver media device 72.

In embodiments, the transport vehicle 12 can be a taxi, a bus, a truck, a van, a limousine, a shuttle boat, a water taxi, an airplane, a boat, or a similar transport vehicle.

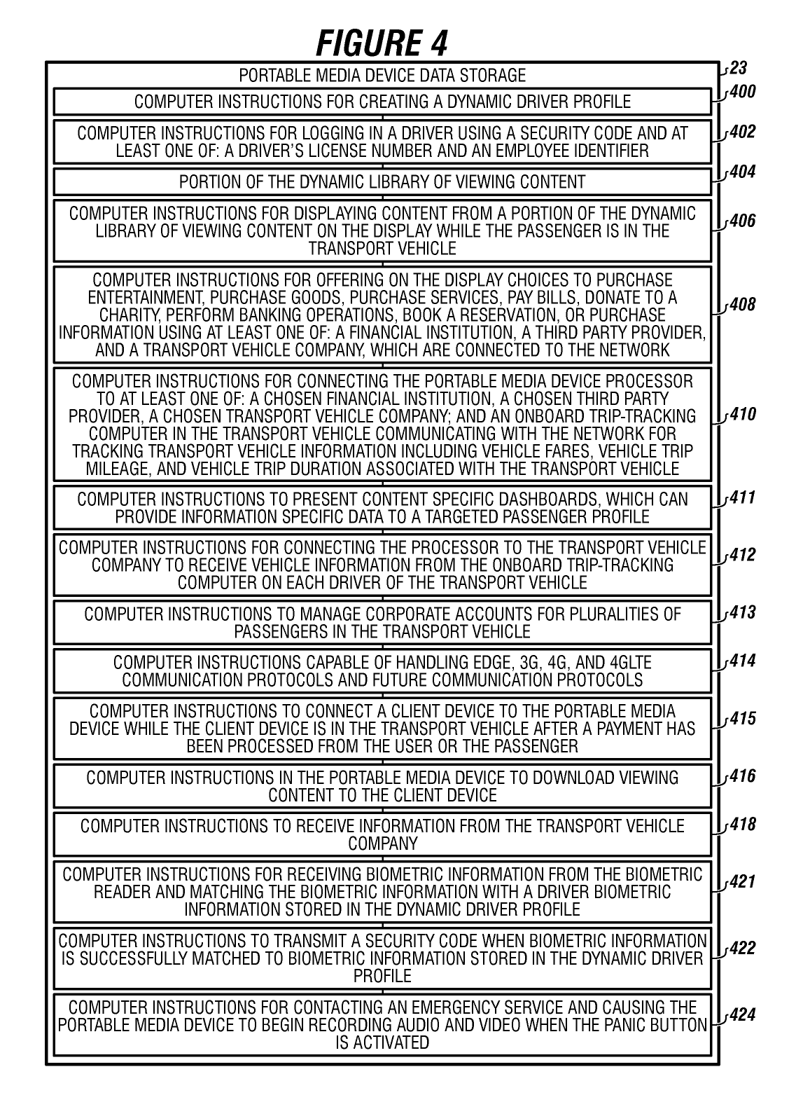

FIG. 4 depicts the portable media device data storage.

The portable media device data storage 23 can include computer instructions 400 for creating a dynamic driver profile.

The portable media device data storage 23 can include computer instructions 402 for logging in a driver using a security code and at least one of: a driver's license number and an employee identifier.

The portable media device data storage 23 can include a portion of the dynamic library of viewing content 404.

The portable media device data storage 23 can include computer instructions 406 for displaying content from a portion of the dynamic library of viewing content on the display while the passenger is in the transport vehicle.

The dynamic library of viewing content can include a passenger selected content, a driver selected content, a preselected content, such as a preselection made by an advertising agency or other third party, a transport vehicle company selected content, or combinations thereof.

The portable media device data storage 23 can include computer instructions 408 for offering choices on the display to purchase entertainment, purchase goods, purchase services, pay bills, donate to a charity, perform banking operations, book a reservation, or purchase information using at least one of: a financial institution, a third party provider, and a transport vehicle company, which are connected to the network.

The portable media device data storage 23 can include computer instructions 410 for connecting the portable media device processor to at least one of: a chosen financial institution, a chosen third party provider, a chosen transport vehicle company, and an onboard trip-tracking computer in the transport vehicle communicating with the network for tracking transport vehicle information including vehicle fares, vehicle trip mileage, and vehicle trip duration associated with the transport vehicle.

The portable media device data storage 23 can include computer instructions 411 to present content specific dashboards, which can provide information specific data to a given targeted passenger profile.

The portable media device data storage 23 can include computer instructions 412 for connecting the processor to the transport vehicle company to receive vehicle information from the onboard trip-tracking computer on each driver of the transport vehicle.

The portable media device data storage 23 can include computer instructions 413 to manage corporate accounts for pluralities of passengers in the transport vehicle.

The portable media device data storage 23 can include computer instructions 414 capable of handling Edge communication protocols, 3G communication protocols, 4G communication protocols, 4GLTE communication protocols, and future communication protocols.

The portable media device data storage 23 can include computer instructions 415 to connect a client device to the portable media device while the client device is in the transport vehicle after a payment has been processed from the user or the passenger.

The portable media device data storage 23 can include computer instructions 416 in the portable media device to download viewing content to the client device.

The portable media device data storage 23 can include computer instructions 418 to receive information from the transport vehicle company.

The information from the transport vehicle company can include dispatch information such as trip start time, trip start location, initial flag charge, total time of the trip, length of the trip, and trip end time.

The information from the transport vehicle company can include cashiering information, such as complete driver's profile, including but not limited to name, employee number and accounting status.

The information from the transport vehicle company can include enterprise resource planning information, such as complete driver's profile, including but not limited to name, employee number and accounting status.

The portable media device data storage 23 can include computer instructions 421 for receiving biometric information from the biometric reader and matching the biometric information with a driver biometric information stored in the dynamic driver profile.

The biometric data can be voice patterns, finger print patterns, retinal scans, and similar biometric data used for the purpose of uniquely identifying a person.

In embodiments, the dynamic driver profile can be stored in the portable media device data storage.

The computer instructions can be used for matching a fingerprint pattern received, a facial pattern received, a voice pattern received, or other commonly used biometric identification patterns for the purpose of uniquely identifying a person to the biometric information stored in the dynamic driver profile.

The portable media device data storage 23 can include computer instructions 422 to transmit a security code when biometric information is successfully matched to biometric information stored in the dynamic driver profile.

The security code can enable the driver to access the system.

The portable media device data storage 23 can also include computer instructions 424 for contacting an emergency service and causing the portable media device to begin recording audio and video when the panic button is activated.

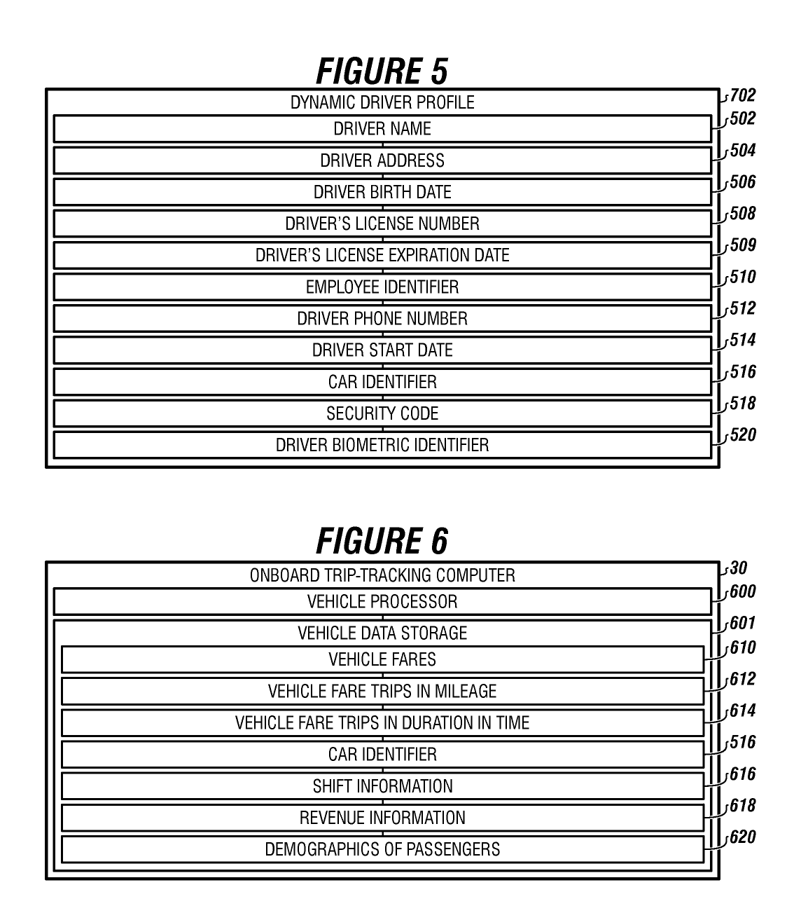

FIG. 5 depicts an embodiment of a dynamic driver profile.

In embodiments, the dynamic driver profile 702 can be stored in the administrative data storage. The dynamic driver profile 702 can include a security code 518, a driver's license number 508, a driver's license expiration date 509, and an employee identifier 510.

In embodiments, the dynamic driver profile 702 can also include a driver name 502, a driver address 504, a driver birth date 506, a driver phone number 512, a driver start date 514, a car identifier 516, and a driver biometric identifier 520.

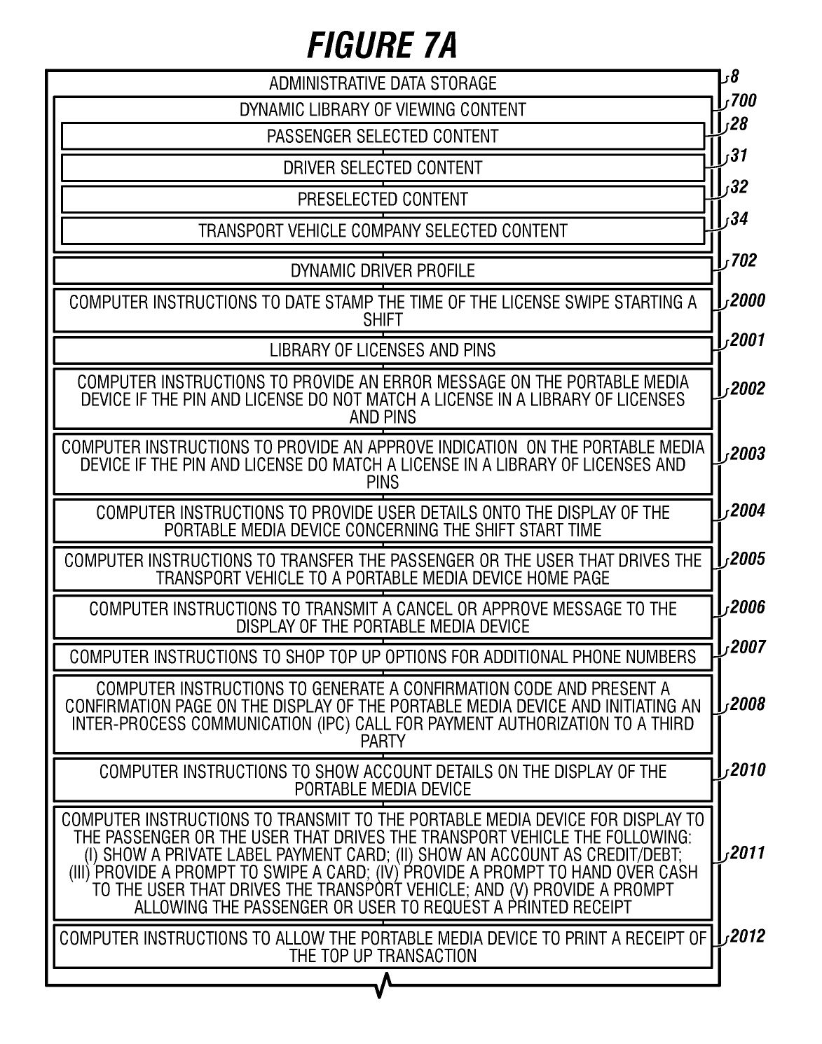

FIG. 6 depicts an embodiment of the onboard trip-tracking computer.

The onboard trip-tracking computer 30 can include a vehicle processor 600 connected to vehicle data storage 601.

The vehicle data storage 601, in embodiments, can include vehicle fares 610, vehicle fare trips in mileage 612, vehicle fare trips in duration in time 614, and/or the car identifier 516.

The vehicle fare trips in duration in time 614 can include vehicle fare trips in duration performed during a defined window of time.

The vehicle data storage 601, in embodiments, can include shift information 616 including start time of a shift and stop time of a shift.

The vehicle data storage 601, in embodiments, can include revenue information 618 on purchased entertainment, purchased goods and services, paid bills, donations to a charity, performed banking operations, booked reservations, or purchased information.

The vehicle data storage 601, in embodiments, can include demographics of passengers 620. Demographics of passengers can include at least one of: gender, ethnicity, and age.

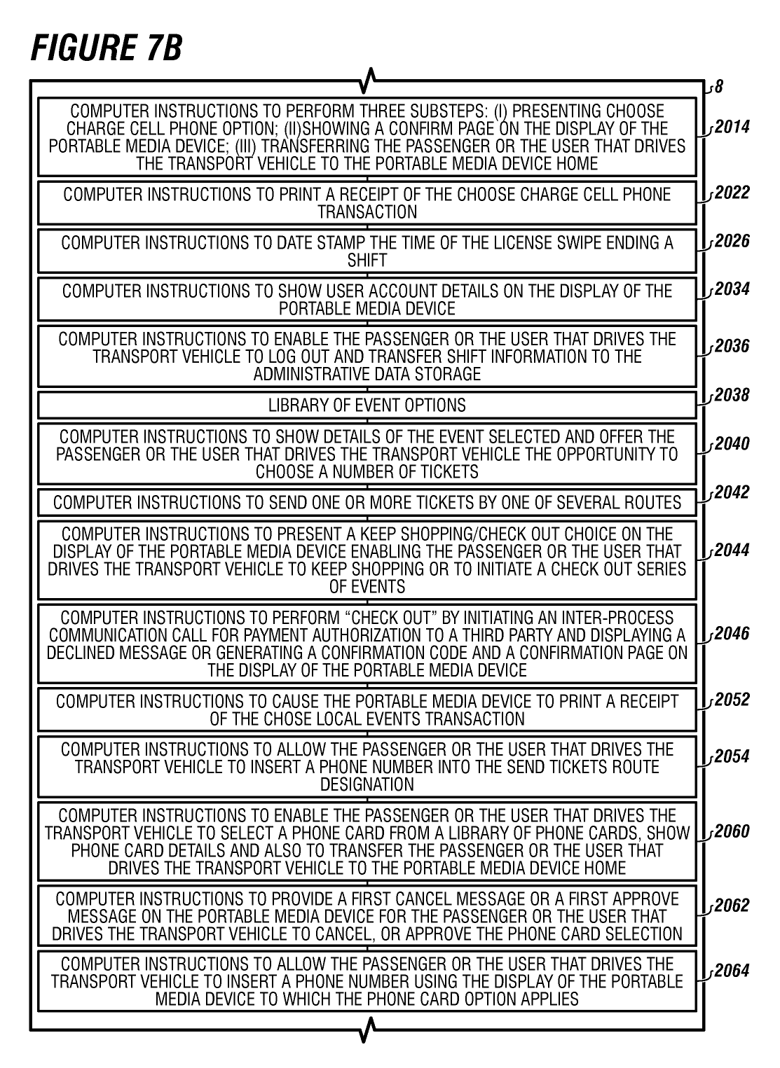

FIGS. 7A-7C depicts an embodiment of the administrative data storage.

The administrative data storage 8 can include the dynamic library of viewing content 700 and at least one dynamic driver profile 702.

The dynamic library of viewing content 700 can include a passenger selected content 28, a driver selected content 31, a preselected content 32, a transport vehicle company selected content 34, or combinations thereof.

The administrative data storage 8 can include a plurality of computer instructions.

The administrative data storage 8 can include computer instructions 2000 to date stamp the time of the license swipe starting a shift.

The administrative data storage 8 can include a library of licenses and personal identification numbers (PINs) 2001.

The administrative data storage 8 can include computer instructions 2002 to provide an error message on the portable media device if the personal identification number (PIN) and license do not match a license in a library of licenses and PINs.

The administrative data storage 8 can include computer instructions 2003 to provide an approve indication on the portable media device if the PIN and license do match a license in a library of licenses and PINs.

The administrative data storage 8 can include computer instructions 2004 to provide user details on the display of the portable media device concerning the shift start time.

The administrative data storage 8 can include computer instructions 2005 to transfer the passenger or the user that drives the transport vehicle to a portable media device home page.

The administrative data storage 8 can include computer instructions 2006 to transmit a cancel or approve message to the display of the portable media device.

The administrative data storage 8 can include computer instructions 2007 to shop top up options for additional phone numbers.

The administrative data storage 8 can include computer instructions 2008 to generate a confirmation code and present a confirmation page on the display of the portable media device and initiating an inter-process communication (IPC) call for payment authorization to a third party.

The administrative data storage 8 can include computer instructions 2010 to show account details on the display of the portable media device.

The administrative data storage 8 can include computer instructions 2011 to transmit to the portable media device for display to the passenger or the user that drives the transport vehicle the following: (i) show a private label payment card; (ii) show an account as credit/debt; (iii) provide a prompt to swipe a card; (iv) provide a prompt to hand over cash to the user that drives the transport vehicle; and (v) provide a prompt allowing the passenger or user to request a printed receipt.

The administrative data storage 8 can include computer instructions 2012 to allow the portable media device to print a receipt of the top up transaction.

The administrative data storage 8 can include computer instructions 2014 to perform three substeps: (i) presenting choose charge cell phone option; (ii) showing a confirm page on the display of the portable media device; (iii) transferring the passenger or the user that drives the transport vehicle to the portable media device home.

The administrative data storage 8 can include computer instructions 2022 to print a receipt of the choose charge cell phone transaction.

The administrative data storage 8 can include computer instructions 2026 to date stamp the time of the license swipe ending a shift.

The administrative data storage 8 can include computer instructions 2034 to show user account details on the display of the portable media device.

The administrative data storage 8 can include computer instructions 2036 to enable the passenger or the user that drives the transport vehicle to log out and transfer shift information to the administrative data storage.

The administrative data storage 8 can include a library of event options 2038.

The administrative data storage 8 can include computer instructions 2040 to show details of the event selected and offer the passenger or the user that drives the transport vehicle the opportunity to choose a number of tickets.

The administrative data storage 8 can include computer instructions 2042 to send one or more tickets by one of several routes.

The administrative data storage 8 can include computer instructions 2044 to present a keep shopping/check out choice on the display of the portable media device enabling the passenger or the user that drives the transport vehicle to keep shopping or to initiate a check out series of events

The administrative data storage 8 can include computer instructions 2046 to perform “check out” by initiating an inter-process communication call for payment authorization to a third party and displaying a declined message or generating a confirmation code and a confirmation page on the display of the portable media device.

The administrative data storage 8 can include computer instructions 2052 to cause the portable media device to print a receipt of the chose local events transaction.

The administrative data storage 8 can include computer instructions 2054 to allow a passenger or the user that drives the transport vehicle to insert a phone number into the send tickets route designation.

The administrative data storage 8 can include computer instructions 2060 to enable the passenger or the user that drives the transport vehicle to select a phone card from a library of phone cards, show phone card details and also to transfer the user to the portable media device home.

The administrative data storage 8 can include computer instructions 2062 to provide a first cancel message or a first approve message on the portable media device for the passenger or the user that drives the transport vehicle to cancel, or approve the phone card selection.

The administrative data storage 8 can include computer instructions 2064 to allow the passenger or the user that drives the transport vehicle to insert a phone number using the display of the portable media device to which the phone card option applies.

The administrative data storage 8 can include computer instructions 2066 to provide a second cancel message, or a second approve message on the portable media device for the passenger or the user that drives the transport vehicle to cancel, or approve the inserted phone number.

The administrative data storage 8 can include computer instructions 2068 to display a keep shopping/check out choice on the display of the portable media device to keep shopping for additional phone card options or initiate a check out.

The administrative data storage 8 can include computer instructions 2076 to print a receipt of the phone card transaction.

The administrative data storage 8 can include computer instructions 2080 to connect the portable media device to the network and enable real time streaming of weather information to the portable media device allowing the passenger or the user that drives the transport vehicle to view a weather description by day on the portable media device, view a weather description by hour on the portable media device, and be transferred the passenger or the user that drives the transport vehicle to a portable media device home after viewing the weather description by day or the weather description by hour.

The administrative data storage 8 can include computer instructions 2090 to enable the passenger or the user that drives the transport vehicle to choose a special offers option on the portable media device.

The administrative data storage 8 can include computer instructions 2092 to allow the passenger or the user that drives the transport vehicle to select a coupon from a dynamic database of coupons.

The administrative data storage 8 can include the dynamic database of coupons 2094.

The administrative data storage 8 can include computer instructions 2096 to show coupon details on the portable media device.

The administrative data storage 8 can include computer instructions 2097 to present a keep choosing/check out choice on the display of the portable media device to keep choosing additional coupons or initiating a check out.

The administrative data storage 8 can include computer instructions 2098 to perform “check out” by sending coupons to the portable media device using an option including at least one of: email, SMS, print, and capture email while allowing for insertion of a phone number during check out.

The administrative data storage 8 can include computer instructions 2099 to transfer the passenger or the user that drives the transport vehicle to the portable media device home after coupon transmission.

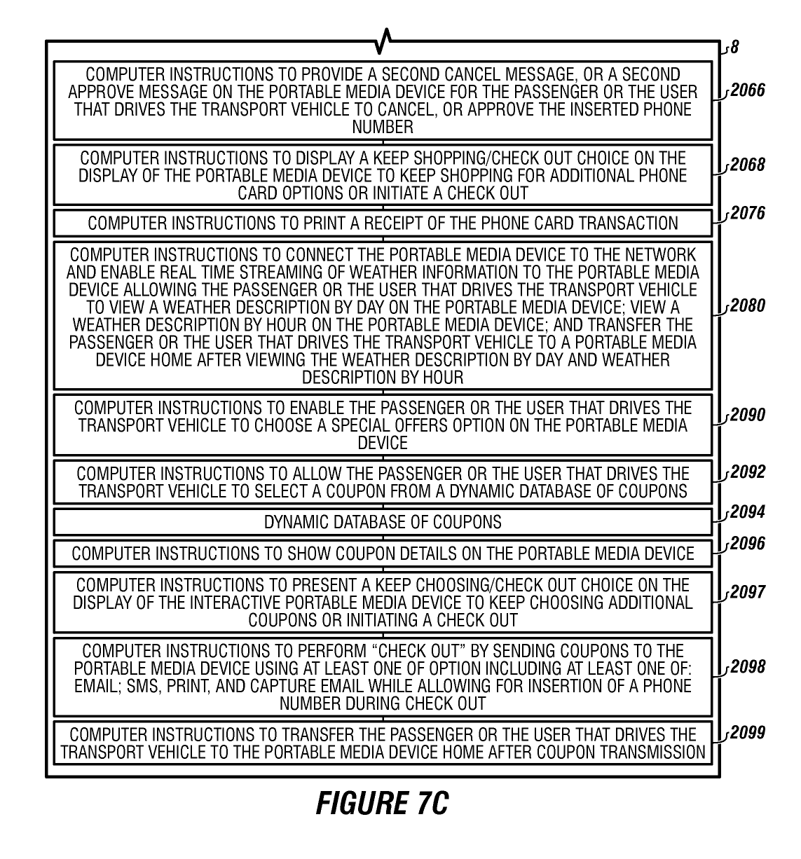

FIG. 8 depicts an embodiment of the portable media device 10 in a holding case 50 mounted to the headrest 56 of the transport vehicle.

The holding case 50 can be connected to a joint 52 adapted for collapsing upon an impact by the transport vehicle into another transport vehicle or into a fixed structure.

In embodiments, the holding case 50 can have rounded edges.

In embodiments, the joint 52 can be made of plastic.

The joint 52 can engage a first post 58 and a second post 60 of the headrest 56.

The holding case 50 can have a single quick connect/quick disconnect connector 54.

The portable media device 10 is shown with the display 21a, a camera 40, and an audio output device 42, shown here as a speaker.

The outlet 36 is depicted for providing a connection to the client device enabling a direct download of information or digital content from the portable media device 10 to the client device or charging of the client device, such as a cell phone, tablet, laptop or DVD player.

The portable media device 10 is also shown with the printer 38 and the biometric reader 33.

The portable media device 10 is also shown with the ability to display local area information 59, an advertisement 61, gaming options 63, and information from the onboard trip tracking computer 30.

In an embodiment, the system can provide connectivity from a transport vehicle to a transport vehicle company, a financial institution, and a third party provider via a network.

In an embodiment, the network can be in communication with an administrative processor and an administrative data storage. The administrative data storage can have a dynamic library of viewing content.

In this embodiment, a portable media device can be installed in a vehicle, such as a taxi cab, for presenting information from the dynamic library of viewing content to a passenger.

The portable media device can have a portable media device processor and a portable media device data storage.

In embodiments, the administrative data storage can provide a portion or all of the dynamic library of viewing content to the portable media device data storage.

The portable media device can have a display for presenting viewing options or selectable content to a passenger of the vehicle. In embodiments, the display can be an interactive touchscreen display.

In an embodiment, the portable media device can have a Smart Panel comprised of an interactive multi-touch display, computer processor and data storage, such as made by Adlink, Inc., a cellular data communication module, such as Sierra Wireless model Air Prime MC7700 LTE, a GPS module such as Siena Wireless model Air Prime MC7700 LTE, a WiFi communication module such as Intel model Intel Centrino Wireless-N 2230, a magnetic strip reader such as Peripheral Dynamics model MMD-1900, a smart chip reader such as Peripheral Dynamics model EICM-1000, a near field communication reader such as Peripheral Dynamics model NFC-1901, a board capable of integrating the magnetic strip reader, the smart chip reader and the near communication reader into one communication port with the Smart Panel, a camera, a thermal printer such as Cashinotech model TP-486F, a power supply such as Mini Com model M3-ATX-125w, a USB port such as Startec model USBMBADAPT2, a speaker such as Advance Acoustic Technology model AK-3208BB-2, and a multi-pin power and data connector.

In embodiments, the passenger can select content to view from the portion of the dynamic library of viewing content in the portable media device data storage, the driver selects content to view, or content to view is predetermined.

In embodiments, the selectable content can include an information element, an advertisement, a video, a service offering from a vendor, a product offering from a vendor, a purchase option, on-line gaming, a promotional offer, output from a connected onboard computer, or combinations thereof.

In embodiments, the information element can be news, weather, stock market information, trip information, or similar information.

In embodiments, advertisements can be tailored to a location of the transport vehicle, time of day, day of year, demographics of the passenger such as age, race or ethnicity, or can be predetermined content.

In embodiments, a video can be a movie, a commercial, a movie clip, a video broadcast, an infomercial, or similar items.

In embodiments, purchase options can be offered for a product or service. The passenger can choose to select an item for purchase on the portable media device.

In embodiments, purchase options can be tailored to a location of the transport vehicle, time of day, day of year, demographics of the passenger such as age, race or ethnicity, or can be predetermined content.

In embodiments, the passenger can select to shop for or purchase goods and services, pay bills, or view information.

When a passenger selects a purchase, the portable media device in embodiments can have a wireless transmitter for communicating with a network and a financial institution.

The passenger can select multiple items to purchase, and combine the items into a single payment transaction.

In embodiments, the portable media device can accept payment from a credit card, debit card, a charge card, a gift card, or other payment cards using manual input, a magnetic card reader, a near field communication reader, a smart chip reader, or other commonly used means of collecting payment.

In embodiments, the system can support two way information exchanges between the portable media device data storage and the administrative data storage. The administrative data storage can wirelessly transmit and receive information from the portable media device data storage.

The administrative data storage can provide all or a portion of the dynamic library of viewing content to the portable media device data storage for selection by a passenger to view, or for display on the portable media device.

In embodiments, the portable media device can have one or more outlets to provide communication, power, or both communication and power.

In embodiments, the portable media data storage can be a removable storage, such as a USB flash memory drive, a memory card, or similar devices capable of storing digital information.

In embodiments, the portable media device can have a Wi-Fi transmitter and receiver for providing a hot spot usable by the passenger to connect to a network, such as a local area network, a wide area network, a satellite network, a global network such as the Internet, or form a peer to peer connection.

The portable media device can be capable of receiving and transmitting information to another computer, such as a taxi meter connected to a transport vehicle company. The portable media device can be used to display, track, and transmit information regarding dispatch, cashiering, or enterprise resource planning.

The portable media device can also include a camera, a speaker, and a microphone enabling a variety of display and recording options. For example, the portable media device can begin recording audio and video upon the panic button being activated. A variety of movies, news, or video clips can be presented to the passenger on the display.

The portable media device can further have a biometric reader to identify a person. The biometric reader can be used to identify the driver of the transport vehicle, the passenger of the transport vehicle, or combinations thereof.

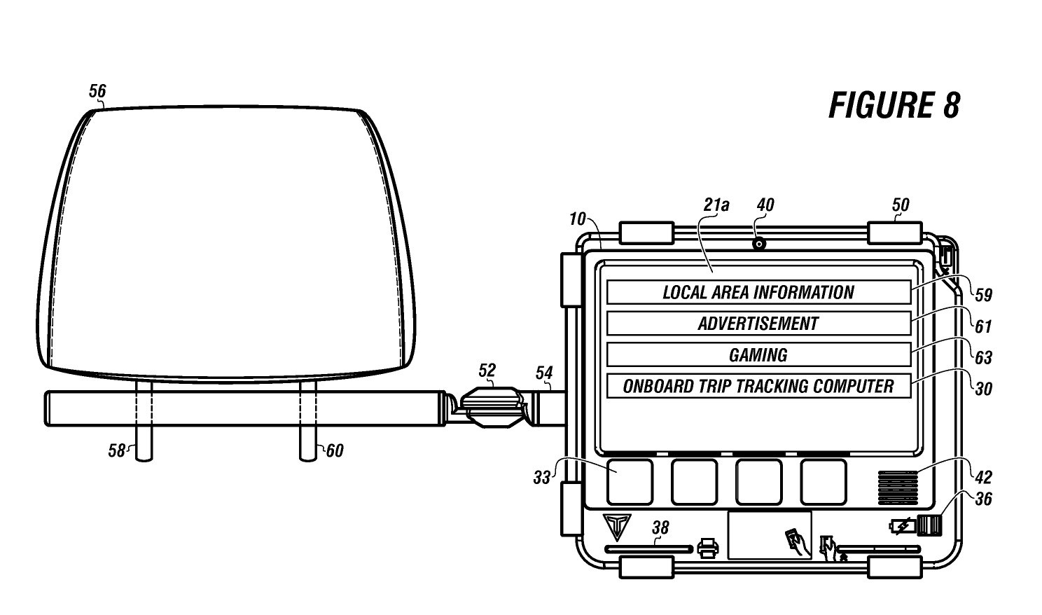

FIG. 9 depicts the steps of the method for driver check in.

A user 900a can check in by swiping a license 902a of the user. The user can be the driver of the transport vehicle.

The checking in can occur on the portable media device that has a magnetic strip reader for driver's licenses.

In this embodiment, computer instructions in the administrative data storage can enable the user 900a to enter a personal identification number (PIN) 904a.

The swiped license information and the personal identification number (PIN) can be stored on the administrative data storage 8 and at the transport vehicle company 26.

Computer instructions in the administrative data storage can be used to date stamp the time of the license swipe starting a shift 908.

In embodiments, the administrative data storage can have computer instructions that provide an error message 910a on the portable media device if the personal identification number (PIN) and license do not match a license and PIN in a library of licenses and PINs in the administrative data storage.

In embodiments, the administrative data storage can have computer instructions that enable the method to provide an approve indication 912a on the portable media device if the personal identification number (PIN) and license do match a license in a library of licenses and PINs in the administrative data storage.

In embodiments, the method can use computer instructions to show user details 914 on the display of the portable media device concerning the shift start time.

The method can involve the step of using computer instructions to transfer the user to a portable media device home page 916a.

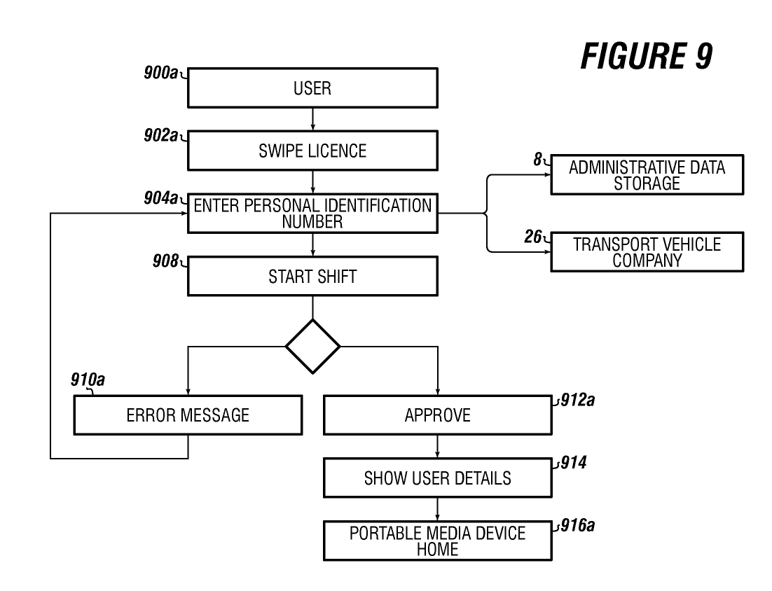

FIG. 10 depicts an embodiment of the steps of the method for a passenger in the transport vehicle or the user that drives the transport vehicle to top up their cell phone with minutes.

A user 900b, which can be the passenger or the user that drives the transport vehicle, can use the portable media device.

First, the method can involve choosing a top up option 918.

Second, the method can involve selecting a carrier 920.

Third, the method can involve choosing an amount for topping up 922.

Fourth, the method can involve showing top up details 924 to the user on the display of the portable media device.

After selecting the carrier, choosing the amount and showing top up details, the user can be transferred, as a fifth step, to the portable media device home 916b.

Next the method can provide a cancel message 926a or an approve message 912b on the portable media device by using computer instructions to transmit a cancel or approve message to the display of the portable media device.

The method can then involve inserting a phone number 928a using the display of the portable media device to which the topping up option relates.

The method can involve providing a cancel message 926b, approve message 912c or an error message 910b on the portable media device for the user to cancel, or approve the top up or to see an error message if the phone number does not exist.

The top up option sequence of steps can next involve displaying a keep shopping/check out choice 930a on the display of the portable media device.

If the keep shopping 932a step is pursued, the user can use computer instructions from the administrative data storage to shop additional products and services.

If the check out 934a step is pursued, computer instructions can perform a check out by initiating an inter-process communication (IPC) call 936 for payment authorization to a third party and displaying a declined message 937a or generating a confirmation code and a confirmation page 938a on the display of the portable media device.

As a next step, computer instructions in the administrative data storage can be activated to show account details 940a on the display of the portable media device.

The method steps relating to account details can further activate computer instructions in the administrative data storage that transmit to the portable media device for display to the user or passenger the following: (i) show a private label payment card 942a; (ii) show an account as credit/debit 944a; and (iii) provide a prompt to hand over cash to the user that drives the transport vehicle 946a.

The method steps relating to account details can further activate computer instructions in the administrative data storage that transmit to the portable media device for display to the user or passenger a prompt allowing the passenger or the user to request a printed receipt 951a.

The top up option method can end with computer instructions in the administrative data storage activating which allow the portable media device to print a receipt 952a of the top up transaction.

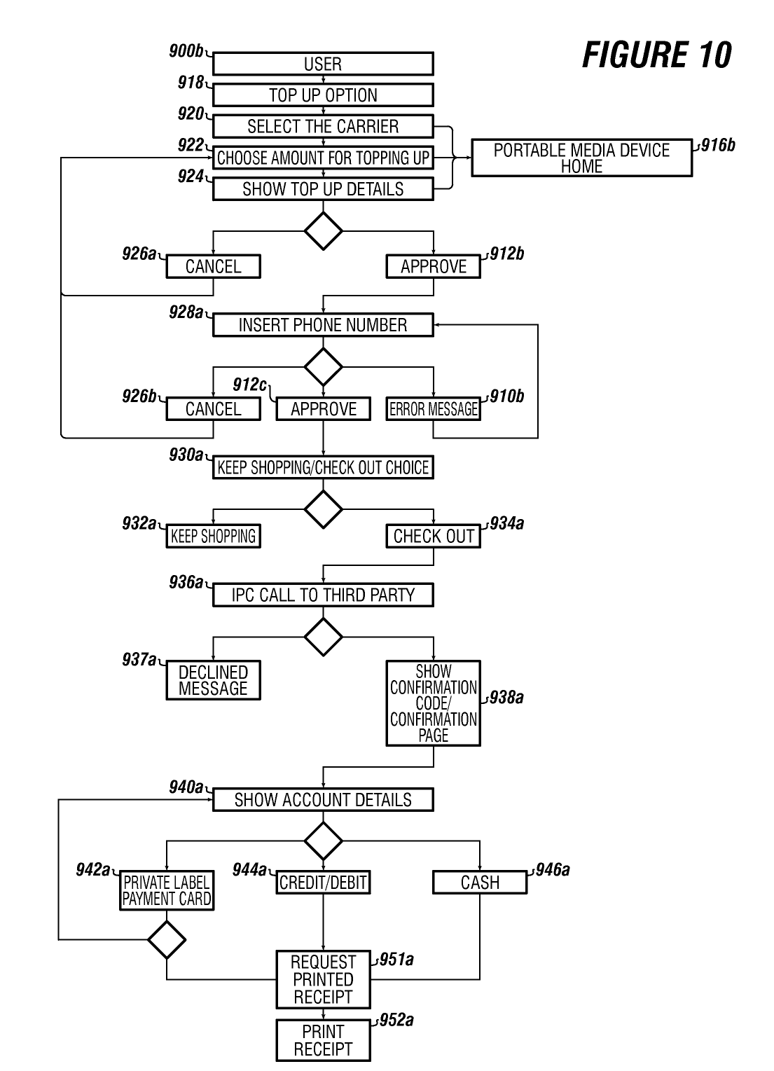

FIG. 11 depicts steps of the method for the user to charge a cell phone.

The steps of the choose charge cellphone option involves presenting a choose charge cell phone option to a user 900c. The user can be the driver of the transport vehicle or a passenger in the transport vehicle.

As a first step, the portable media device can use computer instructions in the administrative data storage to perform three substeps. The first substep involves presenting choose charge cell phone option 962. The second substep involve showing a confirm page on the display of the portable media device 964. The third substep involves transferring the user to the portable media device home 916c.

As a second step, the portable media device can use computer instructions to provide a cancel message 926c or an approve message 912d on the portable media device.

When the cancel message is activated the user can be transferred to the portable media device home 916d. When the approve message is activated, an OK page can be displayed 966. The user can then be presented with a keep shopping or check out page 930b. The user can select to keep shopping 932b or to check out 934b using the portable media device. When the user pursues the check out option the portable media device can perform a check out by initiating an inter-process communication (IPC) call 936b for payment authorization to a third party and displaying a declined message 937b or generating a confirmation code and a confirmation page 938b on the display of the portable media device.

The next step of the method involves showing account details 940b on the display of the portable media device using computer instructions to present the account details on the portable media device.

As a subsequent step of the method, the administrative data storage can then transmit to the portable media device for display to the user using computer instructions to perform at least one of: (i) showing a private label payment card 942b; (ii) showing an account as credit/debit 944b; (iii) providing a prompt to swipe a card; (iv) providing a prompt to hand over cash to the user that drives the transport vehicle 946b; and (v) providing a prompt allowing the passenger or user to request a printed receipt 951b.

As a last step of the method, the user or passenger can activate computer instructions to print a receipt 952b of the choose charge cell phone transaction.

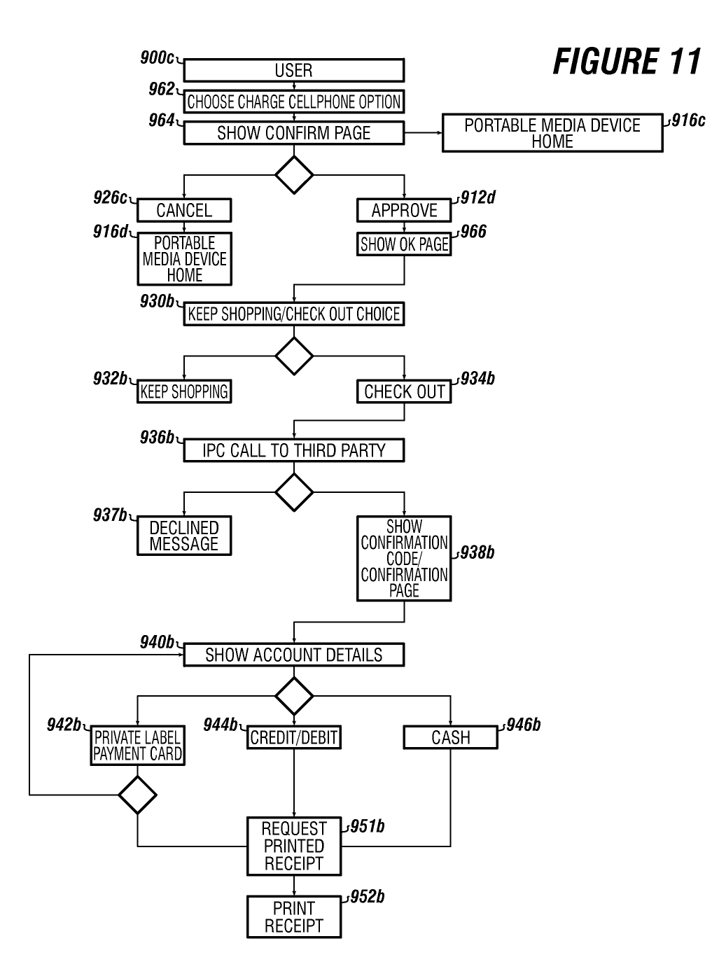

FIG. 12 depicts steps of the method for checking out a user 900d that drives the transport vehicle.

As a first step, the user swipes a license 902b of the user using a reader on the portable media device.

The method can then have the user enter a personal identification number 904b on the portable media device, activating computer instructions to transfer the user to a portable media device home page 916e.

The swiping of the license in the reader of the portable media device can activate computer instructions that date stamp the time of the license swipe ending a shift 968.

Additional computer instructions can provide an error message 910c on the portable media device if the personal identification number (PIN) and license do not match a license and PIN in a library of licenses and PINs in the administrative data storage.

In embodiments, the administrative data storage can have computer instructions that enable the method to provide an approve indication 912e on the portable media device if the personal identification number (PIN) and license do match a license in a library of licenses and PINs in the administrative data storage.

The next step can involve showing user account details 970 on the display of the portable media device using computer instructions.

After showing user account details, computer instructions can show complete shift statistics 972 about the shift on the display of the portable media device.

Finally, the user can log out 974 and shift information can be transferred to the administrative data storage 8 using computer instructions.

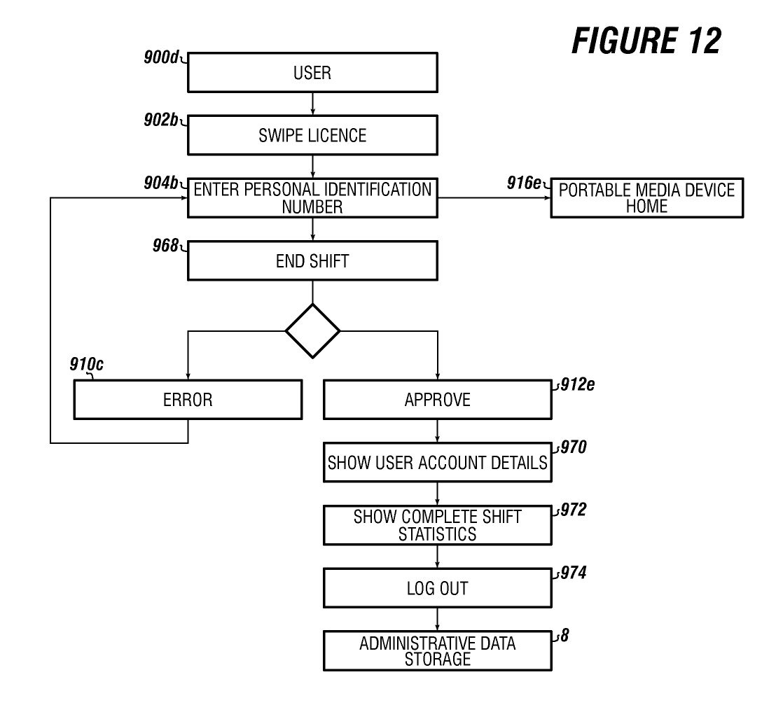

FIG. 13 depicts steps of the method for the user to choose a local events option. In this embodiment, the user can be passenger, such as a passenger in the transport vehicle.

To perform this sequence of steps a user 900e, can perform the step of choose a local events option 976 to access a library of event options in the administrative data storage.

The user can select an event 978 from the library of event options.

The method can include using computer instructions in the administrative data storage to show details of the event selected and offer the user the opportunity to choose a number of tickets 980.

The method can include using computer instructions in the administrative data storage to send tickets by one of several routes 982.

At any time during these steps the user can return to the portable media device home 916f.

In embodiments of the method can then allow the user to designate sending the tickets by at least one of: email 984a, short message service (SMS) 986a, print 988a, and capture email 990a.

The method can include using computer instructions in the administrative data storage to allow a user or passenger to insert a phone number 928b into the send tickets route designation.

The method can include displaying a keep shopping/check out choice 930c on the display of the portable media device to keep shopping 932c or initiate a check out series of events using computer instructions in the administrative data storage.

The user can activate computer instructions to perform check out 934c by performing a check out by initiating an inter-process communication (IPC) call 936c for payment authorization to a third party and displaying a declined message 937c or generating a confirmation code and a confirmation page 938c on the display of the portable media device.

The method can include using computer instructions to present an icon the user can activate to show account details 940c on the display of the portable media device.

Once activated, computer instructions can transmit to the portable media device for display to the user at least one of: (i) a private label payment card 942c; (ii) an account as credit/debit 944c; (iii) a prompt to swipe a card; (iv) a prompt to hand over cash to the user that drives the transport vehicle 946c; and (v) a prompt allowing the user to request a printed receipt 951c.

The method can include activating computer instructions to print a receipt 952c of the chose local events transaction.

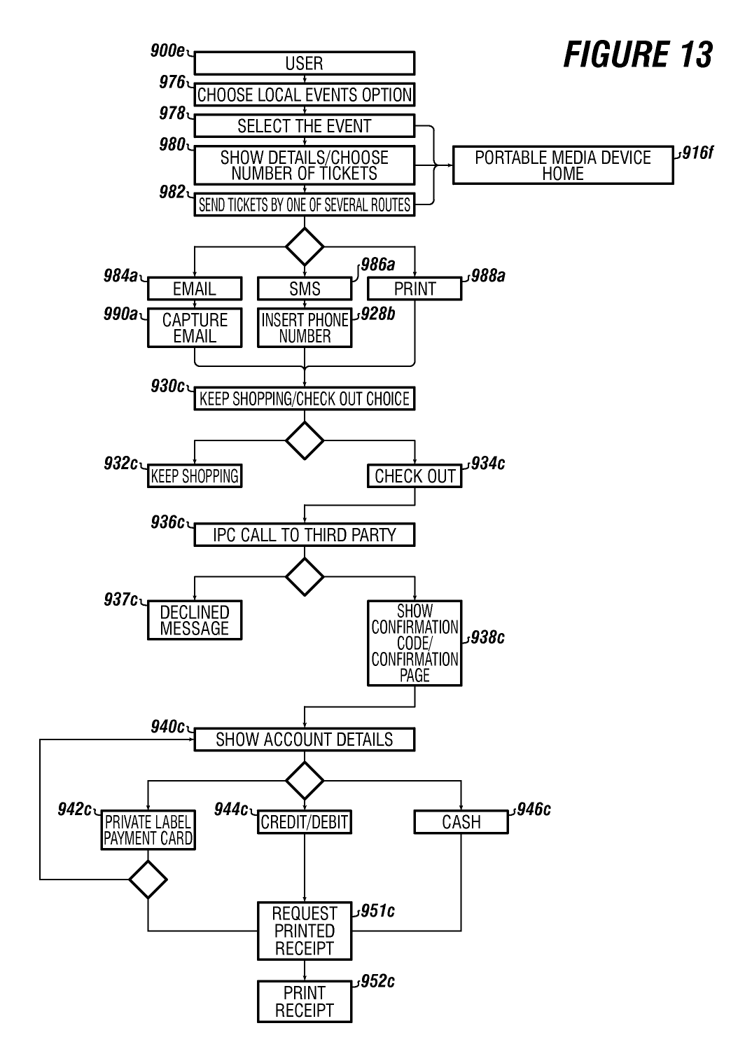

FIG. 14 depicts steps of the method for the user to choose to purchase a phone card. In this embodiment, the user can be a passenger in the transport vehicle.

The method allows a user 900f to choose a phone card option 990 using the portable media device.

Computer instructions in the administrative data storage can enable the user to select a phone card 992 from a library of phone cards, show phone card details 994 and also to transfer the user to the portable media device home 916g.

Computer instructions in the administrative data storage can provide a first cancel message 926d, or a first approve message 912f on the portable media device for the user to cancel or approve the phone card selection.

The method can include allowing a user to insert a phone number 928c using the display of the portable media device to which the phone card option applies using computer instructions in the administrative data storage.

Computer instructions in the administrative data storage can provide a second cancel message 926e, or a second approve message 912g on the portable media device for the user to cancel or approve the inserted phone number.

The method can display a keep shopping/check out choice 930d on the display of the portable media device to keep shopping 932d for additional phone card options or initiate a check out 934d using computer instructions.

Computer instructions in the administrative data storage can enable performing a check out by initiating an inter-process communication (IPC) call 936d for payment authorization to a third party and displaying a declined message 937d or generating a confirmation code and a confirmation page 938d on the display of the portable media device.

Computer instructions in the administrative data storage can show account details 940d on the display of the portable media device.

The method can include transmitting to the portable media device for display to the user or passenger at least one of: (i) showing a private label payment card 942d; (ii) showing an account as credit/debit 944d; (iii) providing a prompt to swipe a card; (iv) providing a prompt to hand over cash to the user that drives the transport vehicle 946d; and (v) providing a prompt allowing the user to request a printed receipt 951d. This step is performed using computer instructions in the administrative data storage.

The method can include printing a receipt 952d of the phone card transaction using computer instructions in the administrative data storage.

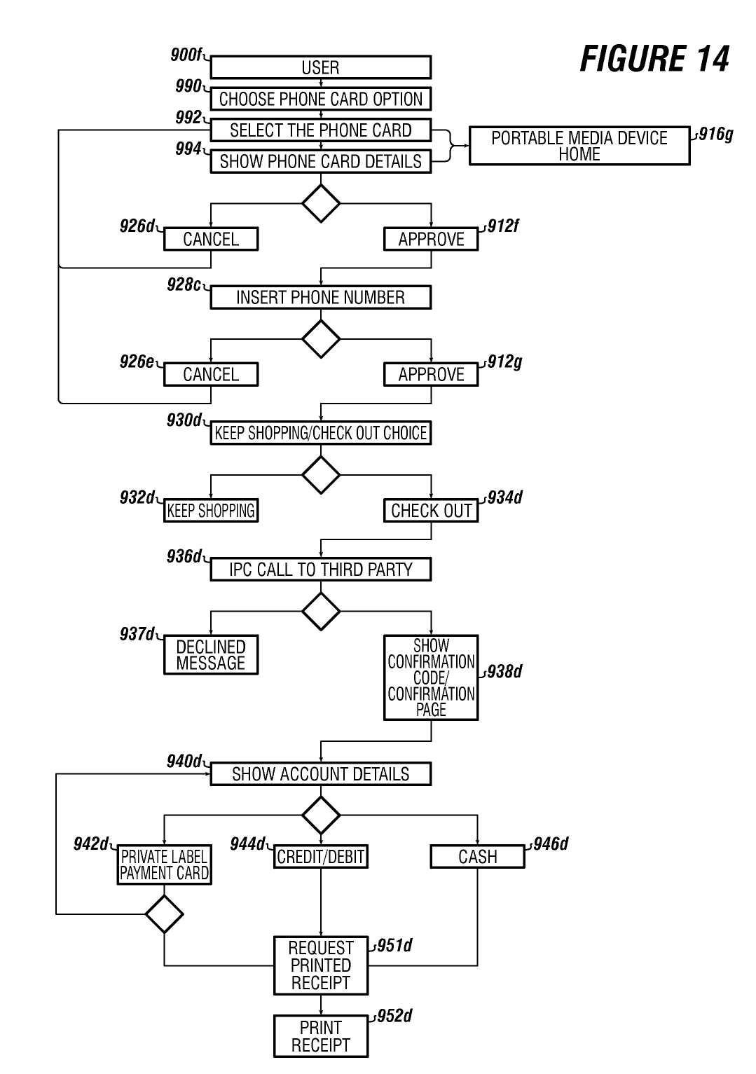

FIG. 15 depicts steps of the method for the user to choose a local weather option and view weather on the portable media device. In this embodiment, the user can be a passenger in the transport vehicle.

For this embodiment, a user 900g can choose a local weather option 996 on the portable media device by: using computer instructions that connect to the network and enable real time streaming of weather information allowing the user to view a weather description by day 998 on the portable media device; view a weather description by hour 1000 on the portable media device; and transfer the user to a portable media device home 916h after viewing the weather description by day and weather description by hour.

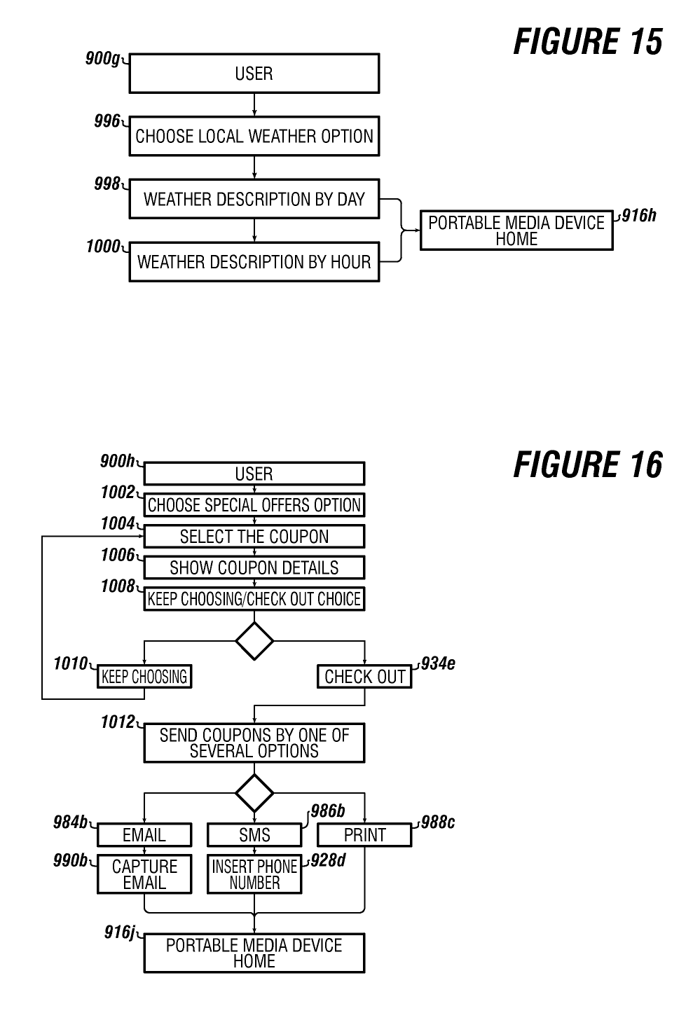

FIG. 16 depicts steps of the method for the user to choose to purchase special offers. In this embodiment, the user can be a passenger in the transport vehicle.

A user 900h can choose a special offers option 1002 on the portable media device using computer instructions in the administrative data storage.

Computer instructions can allow the user to select a coupon 1004 from a dynamic database of coupons.

In embodiments of the method, the user can be shown coupon details 1006 on the portable media device using computer instructions.

In this embodiment, the user can then view a keep choosing/check out choice 1008 on the display of the portable media device to keep choosing additional coupons 1010 or initiate a check out which has been formed using computer instructions in the administrative data storage.

Computer instructions can enable the user to perform check out 934e by sending coupons to the portable media device 1012 using an option including at least one of: email 984b; SMS 986b, print 988c, and capture email 990b while allowing for insertion of a phone number 928d during check out.

The method can include transferring the user to the portable media device home 916j after coupon transmission using computer instructions.

While these embodiments have been described with emphasis on the embodiments, it should be understood that within the scope of the appended claims, the embodiments might be practiced other than as specifically described herein.

1. A method for providing connectivity from a plurality of transport vehicles to a transport vehicle company, a financial institution, a third party provider, and an administrative processor via a network, for use by a passenger and each driver that drives each of the plurality of transport vehicles, the method requiring:
a. an administrative processor connected to an administrative data storage and a network, the administrative data storage having a dynamic library of view content, a plurality of dynamic driver profiles and a plurality of dynamic passenger profiles;
b. connecting the administrative processor to the network and the administrative data storage comprising a non-transitory data storage medium, wherein the administrative processor and the administrative data storage are in a remote location, and wherein plurality of dynamic driver profiles in the administrative data storage further comprises a library of licenses and personal identification numbers (PINs) of drivers of transport vehicles;
c. installing a portable media device having a portable media device processor in each of the plurality of transport vehicles for use by the passenger in one of the plurality of transport vehicles for presenting selected viewing content to the passenger, wherein the portable media device presents an interactive dynamic customized dashboard on a display for entertaining, shopping, paying bills, and information gathering by the passenger; each portable media device connected to a power supply in the transport vehicle and each portable media device having an outlet to provide electricity to a client device in the transport vehicle and a display communicating with the portable media device processor wherein the display is either an interactive touch screen display or a display and a user input mechanism;
d. connecting each portable media device to the network;
e. creating a dynamic driver profile in the portable media device, the dynamic driver profile comprising: a driver's license number, a driver's license expiration date, an employee identifier, and a security code;
f. creating a passenger profile for each passenger in the portable media device;
g. executing computer instructions in the administrative data storage instructing the administrative processor prompting a secure log in of each identify each driver that drives each of the plurality of transport vehicles;
h. executing computer instructions in the administrative data storage instructing the administrative processor prompting a secure log in in each passenger using a security code;
i. executing computer instructions in the administrative data storage instructing the administrative processor presenting at least one activity option to the portable media device in each of the plurality of transport vehicles, wherein the activity option comprises at least one of:
(i) purchasing entertainment from the portable media device processor connected to the administrative data storage and the administrative processor;
(ii) purchasing goods from the portable media device processor connected to the administrative data storage and the administrative processor;
(iii) purchasing services from the portable media device processor connected to the administrative data storage and the administrative processor;
(iv) purchasing information from the portable media device processor connected to the administrative data storage and the administrative processor;
(v) paying bills using the portable media device processor connected to the administrative data storage and the administrative processor;
(vi) donating to a charity using the portable media device processor connected to the administrative data storage and the administrative processor;
(vii) performing banking operations from the portable media device processor connected to the administrative data storage and the administrative processor;
(viii) booking a reservation from the portable media device processor connected to the administrative data storage and the administrative processor; and
(ix) retrieving from the administrative data storage displaying viewing content from a portion of the dynamic library of viewing content on the display of the portable media device to a passenger in the transport vehicle, wherein the content from the dynamic library of viewing content in the administrative data storage, comprises at least one of:
1. a passenger selected content using the administrative processor and the administrative data storage;
2. a driver selected content using the administrative processor and the administrative data storage;
3. a preselected content as determined by the administrative processor using the administrative data storage; and
4. a transport vehicle company selected content using the administrative processor and the administrative data storage;
j. executing computer instructions in the administrative data storage instructing the administrative processor to allow the passenger in each of the plurality of transport vehicles to select one or more activity options;
k. executing computer instructions in the administrative data storage instructing the administrative processor to connect to the financial institution, the transport vehicle company, or the third party provider connected to the network;
l. executing computer instructions in the administrative data storage instructing the administrative processor to perform the one or more activity options selected by the passenger or each driver that drives each of the plurality of transport vehicles; and
m. providing electric power, communication, or both electric power and communication from an outlet on the portable media device to the client device in each of the plurality of transport vehicles.

2. The method of claim 1, wherein each portable media device comprises:
a. a wireless transmitter for remotely communicating with the network and the financial institution;
b. a payment reader connected to the wireless transmitter, wherein the payment reader is at least one of:
(i) a near field communication reader;
(ii) a smart chip communication reader; and
(iii) a magnetic strip communication reader;
c. a portable media device processor communicating with the wireless transmitter; and
d. a portable media device data storage connected to the portable media device processor comprising a non-transitory data storage medium, the portable media device data storage further comprising:
(i);
(ii) computer instructions instructing the portable media device processor to log in a driver using a security code and at least one of: a driver's license number and an employee identifier;
(iii) computer instructions instructing the portable media device processor to connect to the transport vehicle company to receive vehicle information on each driver of the transport vehicle from the onboard trip-tracking computer;
(iv) computer instructions instructing the portable media device processor to present content specific dashboards on the display which can provide information specific data to a targeted passenger profile;
(v) computer instructions instructing the portable media device processor to manage corporate accounts for pluralities of passengers in the transport vehicle; and
(vi) computer instructions for selectively instructing the portable media processor to manage communication between the payment reader and the financial institutions, wherein the instructions enable the portable media device processor to handle Edge communication protocols, 3G communication protocols, 4G communication protocols, and 4GLTE communication protocols between the payment reader and the financial institutions via the network; and
(vii) an outlet for connection to a client device, wherein the outlet provides communication, power, or both communication and power.

3. The method of claim 2, wherein identifying each driver that drives each of the plurality of transport vehicles comprises checking in each driver that drives each of the plurality of transport vehicles by:
a. swiping a license of each driver that drives each of the plurality of transport vehicles using the payment reader;
b. entering a personal identification number on the portable media device and causing the administrative processor to store information about the swiped license and personal identification number in the administrative data storage and at the transport vehicle company;
c. executing computer instructions in the administrative data storage instructing the administrative processor to date stamp the time that the license is swiped, starting a shift;
d. executing computer instructions in the administrative data storage instructing the administrative processor to provide an error message on the portable media device if the personal identification number and swiped license do not match a license and personal identification number in the library of licenses and personal identification numbers in the administrative data storage;
e. executing computer instructions in the administrative data storage instructing the administrative processor to provide an approve indication on the portable media device if the personal identification number and swiped license match a license and personal identification number in the library of licenses and personal identification numbers;
f. executing computer instructions in the administrative data storage instructing the administrative processor to show details of each driver that drives each of the plurality of transport vehicles on the display of the portable media device; and
g. executing computer instructions in the administrative data storage instructing the administrative processor to transfer each driver that drives each of the plurality of transport vehicles to a portable media device home.

4. The method of claim 3, wherein identifying each driver that drives each of the plurality of transport vehicles further comprises checking out each driver that drives each of the plurality of transport vehicles by:
a. swiping a license of each driver that drives each of the plurality of transport vehicles using the payment reader;
b. entering a personal identification number on the portable media device and causing the administrative processor to transfer each driver that drives each of the plurality of transport vehicles to a portable media device home;
c. executing computer instructions in the administrative data storage instructing the administrative processor to date stamp the time that the license is swiped, ending a shift;
d. executing computer instructions in the administrative data storage instructing the administrative processor to provide an error message on the portable media device if the personal identification number and swiped license do not match a license and personal identification number in the library of licenses and personal identification numbers in the administrative data storage;
e. executing computer instructions in the administrative data storage instructing the administrative processor to provide an approve indication on the portable media device if the personal identification number and swiped license do match a license and personal identification number in the library of licenses and personal identification number;
f. executing computer instructions in the administrative data storage instructing the administrative processor to show account details of each driver that drives each of the plurality of transport vehicles on the display of the portable media device;
g. executing computer instructions in the administrative data storage instructing the administrative processor to show complete shift statistics on the shift on the display of the portable media device; and
h. executing computer instructions in the administrative data storage instructing the administrative processor to log out each driver that drives each of the plurality of transport vehicles and transfer shift statistics to the administrative data storage.

5. The method of claim 2, further comprising presenting a top up option to the passenger or each driver that drives each of the plurality of transport vehicles by:
a. executing computer instructions in the administrative data storage instructing the administrative processor to present a top up option on the display of the portable media device;
b. executing computer instructions in the administrative data storage instructing the administrative processor to allow the passenger or each driver that drives each of the plurality of transport vehicles to select a carrier;
c. executing computer instructions in the administrative data storage instructing the administrative processor to allow the passenger or each driver that drives each of the plurality of transport vehicles to choose an amount for topping up;
d. executing computer instructions in the administrative data storage instructing the administrative processor to show top up details to the passenger or each driver that drives each of the plurality of transport vehicles on the display of the portable media device;
e. executing computer instructions in the administrative data storage instructing the administrative processor to transfer the passenger or each driver that drives each of the plurality of transport vehicles to the portable media device home;
f. executing computer instructions in the administrative data storage instructing the administrative processor to provide a cancel message or an approve message on the portable media device for the passenger or each driver that drives each of the plurality of transport vehicles to cancel or approve the amount for topping up;
g. executing computer instructions in the administrative data storage instructing the administrative processor to allow the passenger or each driver that drives each of the plurality of transport vehicles to input to the portable media device a phone number to which the top up option relates;
h. executing computer instructions in the administrative data storage instructing the administrative processor to provide a cancel message, an approve message, or an error message on the portable media device for the passenger or each driver that drives each of the plurality of transport vehicles to cancel or approve the phone number, or provide an error message that the phone number is invalid;
i. executing computer instructions in the administrative data storage instructing the administrative processor to display a keep shopping or check out choice on the display of the portable media device to shop for additional products and services, wherein if keep shopping is selected, displaying to the passenger or each driver that drives each of the plurality of transport vehicles a portable media device home;
j. executing computer instructions in the administrative data storage instructing the administrative processor to perform a check out by initiating an inter-process communication call for payment authorization to a third party;
k. executing computer instructions in the administrative data storage instructing the administrative processor to display a declined message or generating a confirmation code and displaying a confirmation page on the display of the portable media device;
l. executing computer instructions in the administrative data storage instructing the administrative processor to show account details on the display of the portable media device;
m. executing computer instructions in the administrative data storage instructing the administrative processor to transmit to the portable media device a plurality of payment choices to the passenger or each driver that drives each of the plurality of transport vehicles comprising at least one of:
(i) a private label payment card;
(ii) an account as credit/debit; and
(iii) a prompt to hand over cash to each user that drives each of the plurality of transport vehicles;
n. executing computer instructions in the administrative data storage instructing the administrative processor to transmit to the portable media device a prompt allowing the passenger or each driver that drives each of the plurality of transport vehicles to request a printed receipt; and
o. executing computer instructions in the administrative data storage instructing the administrative processor to cause the portable media device to print a receipt.

6. The method of claim 2, further comprising presenting a charge cell phone option to the passenger or each driver that drives each of the plurality of transport vehicles by:
a. executing computer instructions in the administrative data storage instructing the administrative processor to present a charge cell phone option and then showing a confirm page on the display of the portable media device and transferring the passenger or each driver that drives each of the plurality of transport vehicles to the portable media device home;
b. executing computer instructions in the administrative data storage instructing the administrative processor to provide a cancel message or an approve message on the portable media device and when the cancel message is activated transferring the passenger or each driver that drives each of the plurality of transport vehicles to the portable media device home and when approve message is activated displaying a show OK page followed by a keep shopping or check out choice;
c. executing computer instructions in the administrative data storage instructing the administrative processor to transfer each driver that drives each of the plurality of transport vehicles or the passenger to the portable media device home if keep shopping is selected;
d. executing computer instructions in the administrative data storage instructing the administrative processor to perform a check out by initiating an inter-process communication call for payment authorization to a third party;
e. executing computer instructions in the administrative data storage instructing the administrative processor to display a declined message or generating a confirmation code and displaying a confirmation page on the display of the portable media device;
f. executing computer instructions in the administrative data storage instructing the administrative processor to show account details on the display of the portable media device;
n. executing computer instructions in the administrative data storage instructing the administrative processor to transmit to the portable media device a plurality of payment choices to the passenger or each driver that drives each of the plurality of transport vehicles comprising at least one of:
(i) a private label payment card;
(ii) an account as credit/debit; and
(iii) a prompt to hand over cash to each driver that drives each of the plurality of transport vehicles;
g. executing computer instructions in the administrative data storage instructing the administrative processor to transmit to the portable media device a prompt allowing the passenger or each driver that drives each of the plurality of transport vehicles to request a printed receipt; and
h. executing computer instructions in the administrative data storage instructing the administrative processor to cause the portable media device to print a receipt.

7. The method of claim 2, wherein the outlet is selected from the list comprising at least one of:
a. a universal serial bus;
b. a mini-universal serial bus;
c. a micro-universal serial bus;
d. an RS232 outlet;
e. a THUNDERBOLT™ outlet;
f. an IPHONE™ connector outlet; and
g. an IPAD™ connector outlet.

8. The method of claim 2, further comprising connecting a printer with the portable media device processor and to the power supply.

9. The method of claim 2, further comprising connecting a camera with the portable media device processor and the power supply for recording at least one passenger in the transport vehicle.

10. The method of claim 2, further comprising providing an audio output device and a microphone on the portable media device processor connected to the power supply.

11. The method of claim 2, further comprising using as the network at least one of: a cellular network, a global communication network, a satellite network, and a local area network, a wide area network.

12. The method of claim 2, wherein the method operates on at least one of: a taxi, a bus, a truck, a van, a limousine, a shuttle boat, a water taxi, an airplane, and a boat.

13. The method of claim 2, further comprising using as the viewing content at least one of:
a. local area information on historical sites or attractions;
b. an advertisement comprising:
(v) a service offering from a vendor; and
(vi) a product offering from a vendor;
c. online gaming; and
d. an output from an onboard trip-tracking computer.

14. The method of claim 2, further comprising computer instructions in the portable media device data storage instructing the portable media device processor to connect a client device to the portable media device while the client device is in the transport vehicle and after a payment has been processed from each driver that drives each of the plurality of transport vehicles or the passenger.

15. The method of claim 2, further comprising computer instructions in the portable media device data storage instructing the portable media device processor to receive from the transport vehicle company and display on the portable media device at least one of:
a. dispatch information;
b. cashiering information; and
c. enterprise resource planning information.

16. The method of claim 2, comprising computer instructions in the portable media device data storage instructing the portable media device processor to connect the portable media device to a transport vehicle company processor and transport vehicle company data storage and provide transport vehicle information using the network.

17. The method of claim 2, further comprising connecting a driver media device and an onboard trip-tracking computer to the portable media device for providing viewing content to each driver that drives each of the plurality of transport vehicles.

18. The method of claim 2, further comprising a panic button on the portable media device, wherein computer instructions instruct the portable media device processor when the panic button is actuated to contact an emergency service and to automatically begin recording of audio and video by the portable media device.

19. The method of claim 2, further comprising connecting a biometric reader to the portable media device processor and the portable media device data storage and computer instructions in the portable media device data storage instructing the portable media device processor to receive biometric information from the biometric reader and matching the biometric information with a driver biometric information stored in a dynamic driver profile in the portable media device data storage.

20. The method of claim 2, further comprising:
a. executing computer instructions in the administrative data storage instructing the administrative processor to present on the display a local events option;
b. executing computer instructions in the administrative data storage instructing the administrative processor to allow the passenger or each driver that drives each of the plurality of transport vehicles to select an event;
c. executing computer instructions in the administrative data storage instructing the administrative processor to present on the display details of a selected event and to allow the passenger or each driver that drives each of the plurality of transport vehicles to choose a number of tickets;
d. executing computer instructions in the administrative data storage instructing the administrative processor to send a ticket by one of several routes;
e. executing computer instructions in the administrative data storage instructing the administrative processor to display a keep shopping/check out choice on the display of the portable media device to keep shopping or initiate a check out series of events;
f. executing computer instructions in the administrative data storage instructing the administrative processor to perform a check out by initiating an inter-process communication call for payment authorization to a third party;
g. executing computer instructions in the administrative data storage instructing the administrative processor to display a declined message or generate a confirmation code and a confirmation page on the display of the portable media device;
h. executing computer instructions in the administrative data storage instructing the administrative processor to show account details on the display of the portable media device;
i. executing computer instructions in the administrative data storage instructing the administrative processor to transmit to the portable media device a plurality of choices to each driver that drives each of the plurality of transport vehicles or passenger comprising at least one of: (i) a private label payment card; (ii) an account as credit/debit; (iii) a prompt to hand over cash to the driver that drives each of the plurality of transport vehicles;
j. executing computer instructions in the administrative data storage instructing the administrative processor to transmit to the portable media device a prompt allowing the passenger or each driver that drives each of the plurality of transport vehicles to request a printed receipt; and
k. executing computer instructions in the administrative data storage instructing the administrative processor to cause the portable media device to print a receipt of all completed transactions.

21. The method of claim 20, further comprising the step of executing computer instructions in the administrative data storage instructing the administrative processor to cause the portable media device to send tickets by one of several routes, and further allow each driver that drives each of the plurality of transport vehicles or the passenger to designate one or more route comprising at least one of: email, short messaging service, print, and capture email.

22. The method of claim 21, further comprising the step of executing computer instructions in the administrative data storage instructing the administrative processor to allow each driver that drives each of the plurality of transport vehicles or the passenger to designate a route comprising a phone number.

23. The method of claim 2, further comprising:
a. executing computer instructions in the administrative data storage instructing the administrative processor to present on the display a phone card option;
b. executing computer instructions in the administrative data storage instructing the administrative processor to allow the passenger or each driver that drives each of the plurality of transport vehicles to select a phone card;
c. executing computer instructions in the administrative data storage instructing the administrative processor to show phone card details;
d. executing computer instructions in the administrative data storage instructing the administrative processor to transfer each driver that drives each of the plurality of transport vehicles or the passenger to the portable media device home;
e. executing computer instructions in the administrative data storage instructing the administrative processor to provide a first cancel message or a first approve message on the portable media device for the passenger or each driver that drives each of the plurality of transport vehicles to cancel or approve the phone card selection;
f. executing computer instructions in the administrative data storage instructing the administrative processor to allow each driver that drives each of the plurality of transport vehicles or the passenger to insert a phone number using the display of the portable media device to which the phone card option applies;
g. executing computer instructions in the administrative data storage instructing the administrative processor to provide a second cancel message or a second approve message on the portable media device for the passenger or each driver that drives each of the plurality of transport vehicles to cancel or approve the inserted phone number;
h. executing computer instructions in the administrative data storage instructing the administrative processor to display a keep shopping/check out choice on the display of the portable media device to keep shopping for additional products and services;
i. executing computer instructions in the administrative data storage instructing the administrative processor to perform a check out by initiating an inter-process communication call for payment authorization to a third party;
j. executing computer instructions in the administrative data storage instructing the administrative processor to display a declined message or generate a confirmation code and a confirmation page on the display of the portable media device;
k. executing computer instructions in the administrative data storage instructing the administrative processor to show account details on the display of the portable media device;
l. executing computer instructions in the administrative data storage instructing the administrative processor to transmit to the portable media device a plurality of choices to each driver that drives each of the plurality of transport vehicles or passenger comprising at least one of: (i) a private label payment card; (ii) an account as credit/debit; (iii) a prompt to hand over cash to the driver that drives each of the plurality of transport vehicles;
m. executing computer instructions in the administrative data storage instructing the administrative processor to transmit to the portable media device a prompt allowing the passenger or each driver that drives each of the plurality of transport vehicles to request a printed receipt; and
n. executing computer instructions in the administrative data storage instructing the administrative processor to cause the portable media device to print a receipt of all completed transactions.

24. The method of claim 2, further comprising providing a sequence of steps for the passenger or each driver that drives each of the plurality of transport vehicles to choose a local weather option by:
a. executing computer instructions in the administrative data storage instructing the administrative processor to present on the display a local weather option;
b. executing computer instructions in the administrative data storage instructing the administrative processor to allow the passenger or each driver that drives each of the plurality of transport vehicles to view a weather description by day on the portable media device;
c. executing computer instructions in the administrative data storage instructing the administrative processor to allow the passenger or each driver that drives each of the plurality of transport vehicles to view a weather description by hour on the portable media device; and
d. executing computer instructions in the administrative data storage instructing the administrative processor to transfer the passenger or each driver that drives each of the plurality of transport vehicles to a portable media device home after viewing the weather description by day or weather description by hour.

25. The method of claim 2, further comprising providing a sequence of steps for the passenger or each driver that drives each of the plurality of transport vehicles to choose a special offers option by:
a. executing computer instructions in the administrative data storage instructing the administrative processor to present on the display a special offers option;
b. executing computer instructions in the administrative data storage instructing the administrative processor to allow the passenger or each driver that drives each of the plurality of transport vehicles to select a coupon;
c. executing computer instructions in the administrative data storage instructing the administrative processor to show coupon details on the display;
d. executing computer instructions in the administrative data storage instructing the administrative processor to allow the passenger or each driver that drives each of the plurality of transport vehicles to select a specific coupon;
e. executing computer instructions in the administrative data storage instructing the administrative processor to present on the display a keep choosing/check out choice to keep choosing additional coupons or initiate a check out;
f. executing computer instructions in the administrative data storage instructing the administrative processor to perform a check out by sending coupons to the portable media device using at least one of: email, short messaging service, print, and capture email while allowing for insertion of a phone number during check out; and
g. executing computer instructions in the administrative data storage instructing the administrative processor to transfer each driver that drives each of the plurality of transport vehicles to the portable media device home after coupon transmission.
